(19) United States
(12) Patent Application Publication
(10) Pub. No.: US 2026/0177750 A1
(43) Pub. Date: Jun. 25, 2026

(54) RESONANCE CONTROL OF DOUBLE RESONATOR STRUCTURES

(71) Applicant: NVIDIA Corp., Santa Clara, CA (US)

(72) Inventors: Angad Rekhi, San Francisco, CA (US); Nikola Nedovic, San Jose, CA (US)

(73) Assignee: NVIDIA Corp., Santa Clara, CA (US)

(21) Appl. No.: 18/991,481

(22) Filed: Dec. 21, 2024

(51) Int. Cl. G02B 6/293

(52) U.S. Cl. CPC G02B 6/29395; G02B 6/29343

(57) ABSTRACT

Mechanisms to tune resonant frequencies of the resonators in a double resonator structure that includes a first resonator and a second resonator utilizing logic to operate tuning elements to align a dip in the circulating power in the first resonator with a peak in the drop port power of the second resonator.

### BACKGROUND

Machine learning and other computer processor workloads demand higher bandwidth optical connectivity in data centers and other many-processor systems. Photonic link architectures utilizing optical resonant rings (“rings”) or discs may simultaneously satisfy bandwidth and energy efficiency constraints for these optical links.

At the link receiver demultiplexing rings may be applied to separate out data streams at different wavelengths and direct these data streams to separate photodiodes for conversion into electrical signals.

Optical resonators typically comprise a waveguide. The resonance wavelength/frequency of the resonator depends upon the characteristics (e.g., temperature) of this waveguide, and the operation of the link is in turn sensitive to the resonance wavelength. Dynamic (e.g., thermal) control of resonator resonance frequency is therefore often utilized to maintain the rings at desired resonant wavelengths.

Receiver demultiplexers utilizing a single optical resonant ring are sufficiently selective for links in which the channel wavelengths are not too close together. When the data rate per channel is too high relative to the channel spacing, a single ring demultiplexer may drop an unacceptable level of power from an adjacent channel, generating channel crosstalk. In this situation the drop gain of a ring across the bandwidth of a channel it drops may vary to a substantial degree, creating an undesirable low-pass filtering effect on the dropped signal. The resonant frequency of a single ring demultiplexer may be controlled by monitoring the average drop port power and adjusting a resistive heater on the ring to continuously adjust the monitored drop port power to be a maximum level.

A double-ring demultiplexer structure comprises two optically coupled rings: a “bus ring” optically coupled to the waveguide from the transmitter, and a “drop ring” that couples the bus ring to a drop waveguide in the receiver. The bus ring is optically coupled to the drop ring, and together they select the wavelength of interest from the transmitter bus onto the drop bus. The wavelength selectivity of a double-ring demultiplexer structure is higher than for a single ring, reducing channel crosstalk. The flatness of the drop gain is also improved, reducing unwanted signal filtering.

Tuning of the resonant frequency of the rings in a double-ring structure is more complicated than for single-ring structures. Both rings' resonances should be actively maintained in alignment with the desired wavelength to drop in order to compensate for both static resonance variation (due to process variation—e.g., etch depth variation) and dynamic resonance variation (due to, e.g., non-uniform heating of the double ring structure by nearby thermal aggressors during link operation). Conventional double ring structures utilize a single measurement—the average power at the drop port of the drop ring—to select the power delivered to each ring's resonance tuner (e.g., resistive heater).

As noted previously the drop power gain of double-ring structures is substantially flat within the bandwidth of the channel to drop. Consequently the average drop port power provides only a crude measure of the resonance wavelengths of the two rings. It thus becomes complicated and potentially slow to maintain the resonance of the rings in the center of the channel passband, with potentially negative effects on both signal integrity and crosstalk.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an optical link in one embodiment.

FIG. 2 depicts an example of bus ring and drop ring power as a function of wavelength in a double optical resonant ring structure.

FIG. 3 depicts resonance tuning logic for a double optical resonant ring structure in accordance with one embodiment.

FIG. 4 depicts additional aspects of resonance tuning logic for a double optical resonant ring structure in accordance with one embodiment.

FIG. 5 depicts aspects of resonance tuning logic for a double optical resonant ring structure in accordance with another embodiment.

### DETAILED DESCRIPTION

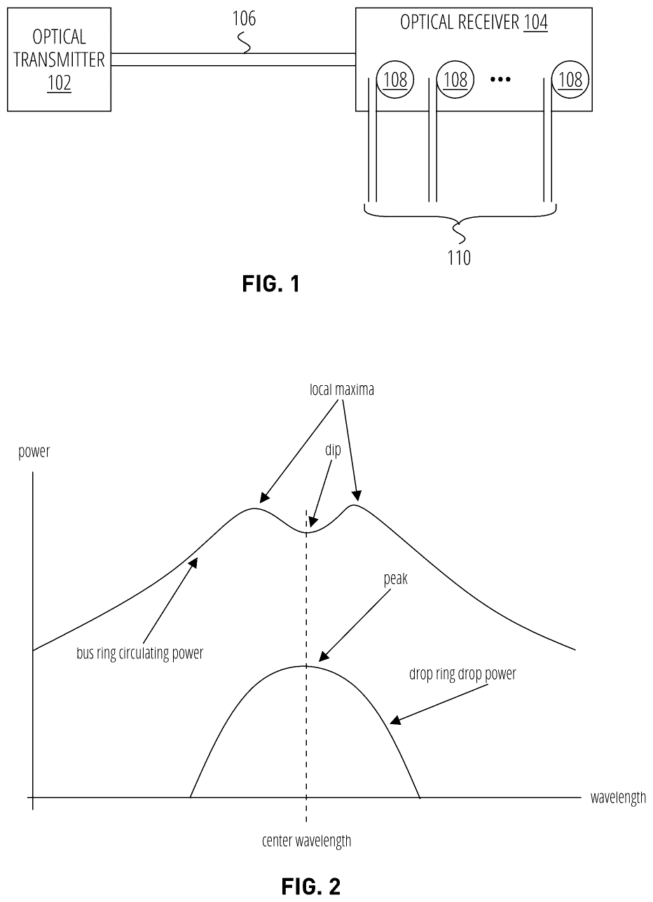

FIG. 1 depicts an optical link in one embodiment. The optical transceiver comprises an optical transmitter 102 and an optical receiver 104 coupled via a waveguide 106. The optical receiver 104 comprises a plurality of resonant structures 108 each having a resonant frequency tuned to drop a particular one of a plurality of wavelengths of data-carrying light signals from the waveguide 106 to one of the waveguides 110. The resonant structure 108 may comprise double resonant structures as described more fully below. Herein, a “double resonant structure” refers to a first resonator coupled to receive light from a first waveguide and a second resonator coupled to drop light on a second waveguide, wherein the first resonator is coupled to drop light to the second resonator.

Disclosed herein are mechanisms to control resonance wavelengths/frequencies of double resonant structures utilizing both of drop power and a sampled circulating power in the bus ring. When both ring resonances are properly tuned, the spectrum of the bus ring circulating power has a narrowband dip between two local maxima at the center of the passband and the drop ring power is at a maximum (see FIG. 2).

The disclosed mechanisms apply the bus ring circulating power and drop ring power as inputs to the ring resonance tuning control logic. The control logic may be implemented in hardware, software, or a combination of the two. The control logic may be implemented in the digital domain or in the analog domain, or in a hybrid combination of the two.

Exemplary embodiments are described utilizing optical resonant rings, but the tuning control mechanisms apply more generally to any resonant optical structure that is “stacked” and tapped in similar fashion, e.g., microdisk resonators.

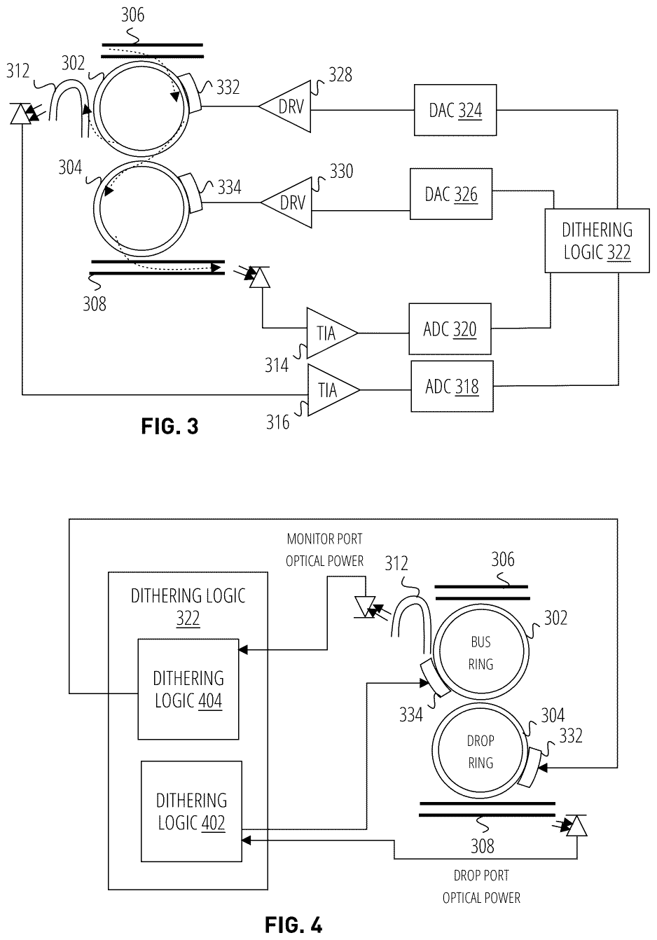

FIG. 3 depicts an embodiment of resonance tuning logic for a double optical resonant ring structure comprising a bus ring 302 and a drop ring 304 coupled between an input waveguide 306 and an output waveguide 308. Dotted arrows depict the flow of optical power. This logic may be deployed for example in an optical dense wavelength division (DWD) optical receiver where the input waveguide 306 is supplied by an optical transmitter with multiple signals centered at different wavelengths, and the double optical resonant ring structure selects one of those wavelengths (modulated with a data signal) to the output waveguide 308.

Photodiodes or other sensors are positioned at the drop port 310 tap of the drop ring 304 and on a monitor port 312 tap of the bus ring 302 circulating power. Transimpedance amplifiers 314, 316 amplify the samples from these sensors as inputs to analog-to-digital converters 318, 320.

Dithering logic 322 responds to the outputs of the analog-to-digital converters 318, 320 by generating control signals which are digitized by digital-to-analog converters 324, 326 and applied via drivers 328, 330 to resonance tuning elements 332, 334 on the bus ring 302 and drop ring 304, respectively. Transimpedance amplifiers 314, 316, analog-to-digital converters 318, 320, digital-to-analog converters 324, 326, and drivers 328, 330 may be implemented in manners known in the art.

Herein “dithering” refers to incrementally increasing or decreasing current, voltage, and/or power of the control signals to the resonance tuning elements 332, 334 depending on the mechanism utilized to implement the resonance tuning elements 332, 334.

In one embodiment the bus ring circulating power is monitored using a photodiode integrated into the internal waveguide of the bus ring 302 thereby providing in situ measurement of the circulating optical power in the bus ring 302 at the cost of some power loss.

The resonance tuning elements 332, 334 may be implemented in various manners according to the needs of the implementation. For example the resonance tuning elements 332, 334 may be implemented as thermo-optic controls in the form of resistive (e.g., metal) elements that heat or cool depending on an amount of applied current. Thermo-optic mechanisms tend to be slower and less efficient than other ring tuning mechanisms but have the benefit of providing resonance tuning over a larger range. Utilizing a doped semiconductor heater alongside the internal ring waveguide may provide a faster, more energy efficient mechanism with less crosstalk than resistive heating, but may provide a more limited range. Free carrier dispersion-based resonance tuning mechanisms such as PiN diode(s) integrated into the ring waveguide may provide the fastest and most energy efficient tuning control and the most limited crosstalk, but may provide the most limited tuning range.

In some embodiments, combinations of resistive or semiconductor heating for a wider tuning range may be combined with dispersion-based resonance tuning mechanisms for speed over a narrower tuning range.

FIG. 4 depicts resonance tuning logic for a double optical resonant ring structure in accordance with one embodiment. The tuning logic utilizes distinct control loops for each ring.

The dithering logic 402 adjusts the signal to the resonance tuning element 334 of the bus ring 302 to maximize the drop power (see FIG. 2). For example the dithering logic 402 may apply more or less current to (dither) the resonance tuning element 334 depending on which side of the peak the drop power is sampled at. The algorithm utilized by the dithering logic 402 may comprise a fixed step size, an adaptive step size (e.g., larger increments or decrements to the applied current depending on the offset extent of the power from the peak), or other maximization-seeking algorithms known in the art.

The dithering logic 404 adjusts the signal to the resonance tuning element 332 of the drop ring 304 to minimize the bus ring circulating power (see FIG. 2).

If just the bus ring 302 drifts away from the optimal tuning point, the circulating power spectrum in the bus ring 302 evolves an asymmetrical shape (one local maxima higher than the other) around the dip but retains a local minimum (the dip) at the desired center wavelength (operating wavelength) to drop. The power spectrum at the drop port of the drop ring 304 may distort (e.g., shift left or right, and down) somewhat as well.

If just the drop ring 304 drifts away from the optimal tuning point, the circulating power spectrum in the bus ring 302 again evolves an asymmetrical shape but now its local minimum (dip) moves away from the desired drop wavelength. The drop power spectrum again distorts somewhat.

The embodiment of the dithering logic 322 depicted in FIG. 4 measures the circulating power in the bus ring 302. The tapped power does not feed back into the structure, so its effect is limited to a minor amplitude loss in the power spectrum.

A resonance tuning control mechanism in accordance with this embodiment may be implemented as follows:
Loop A: The dithering logic 404 adjusts the signal to the resonance tuning element 332 of the drop ring 304 to minimize the circulating power in the bus ring 302 (to seek the largest dip in bus ring 302 circulating power as depicted in FIG. 2). This helps maintain the drop ring 304 resonance at the desired wavelength.
Loop B: The dithering logic 402 adjusts the signal to the resonance tuning element 334 of the bus ring 302 to seek a maximum in the drop port power (to seek the maximal peak in drop ring 304 drop port power as depicted in FIG. 2).

The tuning loops above for the bus ring 302 and the drop ring 304 may be operated at different bandwidths to maintain them both stable and noninteracting. For example, Loop B may be operated at lower bandwidth than Loop A so that from the perspective of Loop B, the drop ring resonance is at the correct setting at any point in time. Any decrease in the drop port power at a given point in time is then attributable to incorrectness of the bus ring resonance position alone.

In one embodiment the faster control loop operates a semiconductor and/or free carrier dispersion-based resonance resonant tuning mechanism, and the slower control loop operates a resistive heating element.

Mechanisms in accordance with this embodiment may be initialized as follows:
1. Based on samples of the drop port power spectrum alone, sweep (e.g., gradually increase the strength of) the signals to the resonance tuning elements 332, 334 at the same time to roughly center the drop port power spectrum at the center wavelength. This may suffice to position the operating wavelength somewhere in between the two local maxima of the bus ring circulating power.
2. Adjust the setting of the resonance tuning element 332 of the drop ring 304 to minimize the measured circulating power in the bus ring 302.
3. Adjust the setting of the resonance tuning element 334 of the bus ring 302 to maximize the drop port power of the drop ring 304.

With embodiments utilizing heating elements as the resonance tuning elements 332, 334 some thermal crosstalk (heating of one ring affecting the resonance frequency of the other) may occur between the two rings. The extent of thermal crosstalk may be pre-characterized and correspondingly less power applied at steps (2) and (3) to the non-selected ring's resonance tuning element to maintain the non-selected ring at a fixed temperature while heating the selected ring. This may be unnecessary if the tuning loop bandwidths are different enough and if thermal crosstalk is sufficiently low.

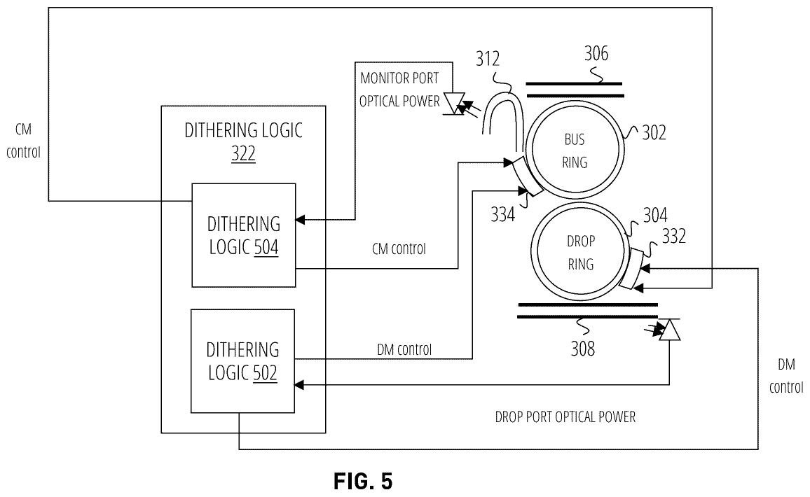

FIG. 5 depicts resonance tuning logic for a double optical resonant ring structure in accordance with another embodiment. A “common mode” (CM) change in ring resonance frequency is a coincident shift (in the same direction) left or right in both ring resonance frequencies, with corresponding shifts in the bus ring and drop ring spectra but without distortion of any spectra. A “differential mode” (DM) change in ring resonance frequency is a coincident shift (in opposite directions) left or right in the ring resonance frequencies.

With a differential mode shift, the bus ring 302 circulating power spectrum becomes asymmetric and its local minimum shifts away from the operating wavelength. Additionally, the drop port power spectrum of the drop ring 304 distorts somewhat and shifts down.

A resonance tuning control mechanism in accordance with this embodiment may be implemented as follows:
Loop A: Dither the differential mode signal (dithering logic 502) to maximize the drop port power.
Loop B: Dither the common mode signal (dithering logic 504) to minimize the monitor port power.

The tuning loops above for the common mode and the differential mode may be operated at different bandwidths to maintain them both stable and noninteracting. For example, Loop B may be operated at lower bandwidth than Loop A so that from the perspective of Loop B, the applied differential mode setting is at the correct setting at any point in time. Hence, any increase in the circulating power of the bus ring 302 may be attributed to an incorrect setting of the common mode signal alone. In one embodiment the faster control loop operates semiconductor and/or free carrier dispersion-based resonance tuning mechanisms, and the slower control loop operates resistive heating elements.

Mechanisms in accordance with this embodiment may be initialized as follows:
1. Based on samples of the drop port power spectrum alone, sweep (e.g., gradually increase the strength of) the common mode control signals to the resonance tuning elements 332, 334 at the same time to roughly center the drop port power spectrum at the center wavelength. This may suffice to position the operating wavelength somewhere in between the two local maxima of the bus ring circulating power.
2. Adjust the differential mode settings of the resonance tuning elements 332, 334 to maximize the drop port power of the drop ring 304.
3. Adjust the common mode settings of the resonance tuning elements 332, 334 to minimize the measured circulating power in the bus ring 302.

### LISTING OF DRAWING ELEMENTS

102 optical transmitter
104 optical receiver
106 waveguide
108 resonant structure
110 waveguide
302 bus ring
304 drop ring
306 input waveguide
308 output waveguide
310 drop port
312 monitor port
314 transimpedance amplifier
316 transimpedance amplifier
318 analog-to-digital converter
320 analog-to-digital converter
322 dithering logic
324 digital-to-analog converter
326 digital-to-analog converter
328 driver
330 driver
332 resonance tuning element
334 resonance tuning element
402 dithering logic
404 dithering logic
502 dithering logic
504 dithering logic

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. §112(f) for that claim element. Accordingly, claims in this application that do not otherwise include the “means for” [performing a function] construct should not be interpreted under 35 U.S.C. §112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A system comprising:
a double resonator structure comprising a first resonator and a second resonator; and
tuning logic configured to align a dip in a circulating power in the first resonator with a peak in a drop port power of the second resonator.

2. The system of claim 1, wherein the tuning logic is configured to:
adjust a resonance tuning element of the second resonator to minimize the circulating power in the first resonator; and
adjust a resonance tuning element of the first resonator to maximize the drop port power of the second resonator.

3. The system of claim 1, wherein the tuning logic is configured to:
minimize the dip in the circulating power; and
maximize the peak in the drop port power.

4. The system of claim 3, wherein the tuning logic is further configured to:
operate to minimize the dip in the circulating power in the first resonator at a first rate; and
operate to maximize the peak in the drop port power at a second rate different than the first rate.

5. The system of claim 1, wherein the tuning logic is configured to:
apply a differential mode control signal to the double resonator structure to maximize the drop port power; and
adjust a common mode control signal to the double resonator structure to minimize the circulating power in the first resonator.

6. The system of claim 5, wherein the tuning logic is further configured to:
adjust the common mode control signal at a different rate than a rate of adjusting the differential mode control signal.

7. The system of claim 1, further comprising:
the tuning logic configured to monitor the circulating power in the first resonator via a photodiode integrated into a waveguide of the first resonator.

8. The system of claim 1, the tuning logic configured to monitor the circulating power in the first resonator via a tap port on the first resonator.

9. The system of claim 1, further comprising:
the tuning logic configured to control one or more resistive heating elements thermally coupled to the double resonator structure.

10. The system of claim 1, further comprising:
the tuning logic configured to control one or more doped semiconductor heating elements thermally coupled to the double resonator structure.

11. The system of claim 1, further comprising:
the tuning logic configured to control a free carrier dispersion-based resonance tuning mechanism integrated into one or more internal waveguides of the double resonator structure.

12. The system of claim 1, further comprising:
the tuning logic configured to control a combination of one or more heating elements thermally coupled to the double resonator structure and a free carrier dispersion-based resonance tuning mechanism integrated into one or more internal waveguides of the double resonator structure.

13. An optical receiver comprising:
a double resonator structured demultiplexer comprising a first resonator and a second resonator;
dithering logic configured to:
adjust a resonance tuning element of the first resonator to maximize a drop port power of the second resonator; and
adjust a resonance tuning element of the second resonator to minimize a circulating power in the first resonator.

14. The optical receiver of claim 13, wherein the dithering logic is configured to:
align a dip in the circulating power in the first resonator with a peak in the drop port power of the second resonator.

15. The optical receiver of claim 13, wherein the dithering logic is configured to:
minimize a dip in the circulating power of the first resonator; and
maximize a peak in the drop port power of the second resonator.

16. The optical receiver of claim 15, wherein the dithering logic is further configured to:
operate to minimize the dip in the circulating power in the first resonator at a first rate; and
operate to maximize the peak in the drop port power at a second rate different than the first rate.

17. The optical receiver of claim 13, wherein the dithering logic is configured to:
apply a differential mode control signal to the double resonator structure to maximize the drop port power; and
adjust a common mode control signal to the double resonator structure to minimize the circulating power in the first resonator.

18. The optical receiver of claim 17, wherein the dithering logic is further configured to:
adjust the common mode control signal at a different rate than a rate of adjusting the differential mode control signal.

19. The optical receiver of claim 13, the dithering logic further configured to:
monitor the circulating power via a photodiode integrated into a waveguide of the first resonator.

20. The optical receiver of claim 13, the dithering logic further configured to:
monitor the circulating power via a tap port on the first resonator.

21. The optical receiver of claim 13, the dithering logic further configured to:
control one or more resistive heating elements thermally coupled to the double resonator structure.

22. A system comprising:
a double resonator structure comprising a first resonator and a second resonator;
logic configured to minimize a dip in a circulating power of the first resonator at a first rate; and
operate to maximize a peak in a drop port power of the second resonator at a second rate different than the first rate.
